(19) United States
(12) Patent Application Publication
(10) Pub. No.: US 2026/0121530 A1
(43) Pub. Date: Apr. 30, 2026

(54) VOLTAGE STABILIZATION WITH ON-DEVICE METAL CAPACITOR

(71) Applicant: Arm Limited, Cambridge (GB)

(72) Inventors: Yimajian Yan, Santa Clara, CA (US); Ashwani Kumar Srivastava, Austin, TX (US); El Mehdi Boujamaa, Valbonne (FR); Tirdad Anthony Takeshian, Vence (FR); Marlin Wayne Frederick, JR., Austin, TX (US); Mikaël Yves Marie Rien, Claix (FR)

(21) Appl. No.: 18/934,079

(22) Filed: Oct. 31, 2024

(51) Int. Cl. H02M 3/06; H02M 3/137

(52) U.S. Cl. CPC H02M 3/06; H02M 3/137

(57) ABSTRACT

An integrated circuit assembly comprises a plurality of die connection points configured to couple to an integrated circuit die, and a plurality of external connection points configured to couple to external circuitry. A metal power signal trace and a metal ground signal trace are each coupled to at least a respective one of the plurality of die connection points to provide electrical power to the integrated circuit. A first metal-insulator-metal capacitor comprises a plurality of first extensions interleaved with a plurality of extensions of the metal power signal trace and is separated from the plurality of extensions of the metal power signal trace by an insulator. A second metal-insulator-metal capacitor comprises a plurality of second extensions interleaved with a plurality of extensions of the metal ground trace and is also separated from the plurality of extensions of the metal ground trace by an insulator.

### FIELD

The field relates to power management, and more specifically to voltage stabilization with an on-device metal capacitor.

### BACKGROUND

Modern computerized devices process and store information in a variety of ways, including using processors that may have multiple cores and cache memory that may be associated with each of at least some of the processor cores. The processors in modern high-performance consumer electronics devices such as smart phones, tablet computers, set top boxes, and the like, may have different processor cores with different capabilities, such as high-performance processor cores that can perform a high number of operations per second but that may consume a significant amount of power, and efficient cores that may perform tasks more efficiently but at a lower peak number of instructions per second than high performance cores. In some further examples, at least some of the high-performance cores and/or efficient cores may have configurable performance levels, such as underdriven or overdriven voltage levels and corresponding faster or reduced operating speeds.

Processor cores in some examples may be powered up or down as needed, and in further examples may have one or more different available performance levels (and associated efficiency levels) per core. For example, a demanding video game involving rendering many objects in real time may use both high-performance cores and all four high-efficiency cores in a smartphone, while a simple task like reading email may use a single high-efficiency core. Cores may therefore be selectively powered up or selectively employed to process program instructions depending on the task load in a computing device, typically involving significant changes in power demand as different processor cores are made active or employed to process instructions.

Multi-core processors in modern computing systems may also have their own cache memory, such as a dedicated level one (L1) or level two (L2) cache memory associated with some or all of the respective processor cores in the multi-core processor. L1 or L2 cache local to one or more processor cores may store frequently-used data local to the respective cores, which may make retrieval of this often-used data faster than if the same data was retrieved from Level 3 (L3) cache or main memory (or DRAM) that is typically slower and physically more remote. Cache memory may typically contain tens of thousands or hundreds of thousands (or more) of words of data per core, comprising a significant percentage of the die area, transistor count, and power consumed by the integrated device, and may be powered up and down or switched between active and inactive power states as processor cores are powered up and down.

When processor cores are powered on to provide greater computing resources for a computing system, they quickly draw significantly more current than before the cores and cache were powered, potentially causing a droop in voltage provided to the processor circuits. Voltage regulators are often therefore designed to provide reduced or low voltage drops, and capacitors located near the processor circuits known as bypass capacitors store extra energy that can be drawn during such transitions in power state. But, voltage regulator circuitry may be slow to respond, and bypass capacitors located near a processor core are often limited in the amount of power they can provide. For reasons such as these, a need exists for improved voltage stabilization in powering integrated circuits such as processor cores and associated cache memory.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 shows a computerized system employing voltage stabilization with on-device metal-insulator-metal capacitors, consistent with an example embodiment.

FIG. 2 shows an integrated circuit redistribution layer (RDL), as may be used to practice some example embodiments.

FIG. 3 shows a redistribution layer comprising a plurality of switched metal-insulator-metal capacitors that occupy approximately 50% of the overall capacitor area in a redistribution layer, consistent with an example embodiment.

FIG. 4 shows charging and discharging switched capacitors via a voltage stabilization circuit, consistent with an example embodiment.

FIG. 5 shows an alternate redistribution layer comprising a plurality of switched metal-insulator-metal capacitors that occupy approximately 100% of the overall capacitor area in a redistribution layer, consistent with an example embodiment.

FIG. 6 shows a redistribution layer comprising a plurality of switched metal-insulator-metal capacitors that extend over the die area of processor cores not employing the switched metal-insulator-metal capacitors, consistent with an example embodiment.

FIG. 7 is a power supply signal timing diagram showing power supply variations with and without a voltage stabilization circuit, consistent with an example embodiment.

FIG. 8 is a power signal timing diagram showing how selecting a voltage stabilization circuit discharge rate may improve voltage stabilization, consistent with an example embodiment.

FIG. 9 is a flow diagram of a method of using a voltage stabilization circuit with metal-insulator-metal capacitors to reduce voltage droop in an integrated circuit, consistent with an example embodiment.

FIG. 10 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Many modern computing systems employ processors with multiple processing cores, such that certain tasks that can be performed in parallel can be distributed among the cores for faster execution or different tasks can be performed simultaneously by different processors. Simple tasks such as checking an email may only use one processor core, while more complex tasks such as rendering a video game in real time may use all available cores. The processor cores in further examples may be associated with cache memory local to one or more of the respective processor cores, operable to store information that the processor core is likely to need for executing program instructions using local SRAM for fast access.

In some examples the different processor cores may also include different types of circuits, such as high performance processor cores, high efficiency processor cores, memory, and other such circuits. These circuits may vary in power demand, in physical location on the die, and on power demand per unit of area on the die. Powering processor cores and their related caches up and down changes the current drawn from the power source for the processor cores (and, in some further examples, associated cache memory), and may cause a temporary droop in supplied voltage while the voltage regulator or other power supply components recover from the increased demand for power. This voltage drop may be controlled to some degree using methods such as a low-dropout voltage regulator that responds somewhat quickly to changes in drawn current, by using bypass capacitors to store extra charge that is available to help meet a sudden demand for additional current, or through other such means. But, the impedance of low-dropout voltage regulator may limit its ability to respond quickly to changes in power demand, even if the low-dropout voltage regulator is physically near the high-performance processor core. Bypass capacitors are often either located off-device and somewhat slow to provide power, such as bypass capacitors located on a circuit board near an integrated circuit, or may be limited in size and lack the power capacity to effectively manage significant and rapid changes in current drawn if located on an integrated circuit device.

Some examples presented herein therefore provide for on-device metal-insulator-metal capacitor structures designed to provide significant energy storage while being physically near the powered circuit. The capacitor structures in further examples may have a low discharge impedance to quickly respond to changes in current demand, or may have a discharge impedance selected to provide current at a desired rate, such as based on a first order resonance of anticipated voltage droop. In one such example, an on-device capacitor structure includes an integrated circuit along with a metal power distribution layer comprising a metal power signal trace and a metal ground signal trace. The metal power distribution layer is coupled to the integrated circuit to provide electrical power to the integrated circuit. A first metal-insulator-metal capacitor comprises a plurality of first extensions interleaved with a plurality of extensions of the metal power signal trace, and is separated from the plurality of extensions of the metal power signal trace by a first insulator. A second metal-insulator-metal capacitor similarly comprises a plurality of second extensions interleaved with a plurality of extensions of the metal ground trace, and is separated from the plurality of extensions of the metal power signal trace by a second insulator.

In another example, a machine-readable medium such as a disk drive, nonvolatile memory, or the like may store computer-readable hardware description language code for fabrication of a device. In one such example, the device may include code for fabrication of a plurality of die connection points configured to couple to an integrated circuit die, and for a plurality of external connection points configured to couple to external circuitry. The device may further include code for fabrication of a metal power signal trace and a metal ground signal trace, the metal power signal trace and metal ground signal trace each coupled to at least a respective one of the plurality of die connection points to provide electrical power to the integrated circuit. The device may further include code for fabrication of a first metal-insulator-metal capacitor comprising a plurality of extensions interleaved with a plurality of extensions of the metal power signal trace and separated from the plurality of extensions of the metal power signal trace by a first insulator, and a second metal-insulator-metal capacitor comprising a plurality of second extensions interleaved with a plurality of extensions of the metal ground signal trace and separated from the plurality of extensions of the metal ground signal trace by a second insulator.

The first and second capacitors may be charged and discharged using a transmission gate or other suitable switching method. In a further example, the resistance-capacitance (RC) time constant of the discharge circuit is controlled such as through semiconductor process, circuit device configuration or layout, or other such means to provide an RC constant of the first metal-insulator-metal capacitor, the a first metal-insulator-metal capacitor, and the at least one switching circuit of between 0.03 and 0.3 divided by a resonance frequency of a first order voltage droop of the integrated circuit in response to a change in drawn electrical power. In a further example the RC time constant of the first metal-insulator-metal capacitor, the a first metal-insulator-metal capacitor, and the at least one switching circuit of between 0.08 and 0.10 divided by a resonance frequency of a first order voltage droop of the integrated circuit in response to a change in drawn electrical power.

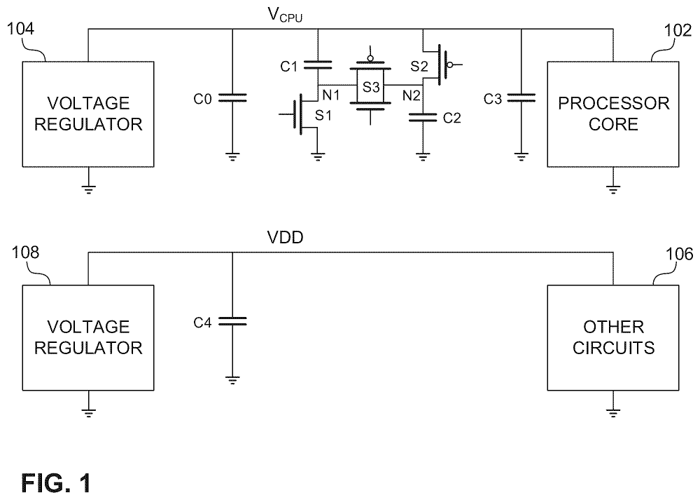

FIG. 1 shows a computerized system employing voltage stabilization with on-device metal-insulator-metal capacitors, consistent with an example embodiment. Here, an integrated circuit including a processor core comprises two voltage domains, a V_{CPU} voltage domain for processor core or cores 102 and a VDD voltage domain for efficient cores 104, memory, peripheral or control circuits, and other such circuits. The processor core 102 is coupled to a voltage regulator 104 that is operable to regulate or control the voltage of the power signal provided to processor core 102. Bypass capacitor C0 may be located on a printed circuit board adjacent to the integrated circuit, integrated into the integrated circuit, or part of a multi-chip module or integrated circuit package in various examples.

A voltage stabilizer circuit comprising capacitors C1-C2 and transistors S1-S3 may be operable to stabilize the voltage of the coupled voltage supply signals during transitions in drawn current, such as when a processor workload increases. The voltage stabilizer circuit shown here comprises a first capacitor C1 and a second capacitor C2 that are selectively charged during periods of stable current load, and are selectively discharged during periods of increasing current load. The capacitors C1 and C2 may be charged by turning on transistors S1 and S2 while turning off transmission gate S3, and may be discharged by turning off transistors S1 and S2 while turning on transmission gate S3. When the transmission gate S3 is turned off and transistors S1 and S2 are turned on, the capacitors C1 and C2 are connected in parallel between ground and V_{CPU}. The capacitors C1 and C2 are each charged to a charge Q in Coulombs determined by the equation Q=CV, where C is the capacitance of each capacitor and V is the applied charging voltage V_{CPU}. When transmission gate S3 is turned on and transistors S1 and S2 are turned off, the capacitors are connected in series rather than in parallel between ground and V_{CPU}, resulting in a discharge of the energy of both capacitors into the voltage supply V_{CPU} to stabilize the voltage during an increase in drawn current.

Advantages of the voltage stabilizer circuit can be seen by comparing the energy released by a single capacitor having the capacitance of C1+C2 when compared with the energy released by a pair of capacitors C1 and C2 that are each charged using the full voltage V_{CPU} but discharged in series. In one such example, the energy released by a single 90 nF capacitor coupled between V_{CPU} at 0.95 v with a 10% maximum acceptable voltage drop is given by expression [1] as follows:

$$90 nF ( 10 \% * 0.95 v ) ( 95 \% * 0.95 v ) = 7.72 nJ \qquad [ 1 ]$$

where 90 nF is the capacitance of the capacitor, (10%*0.95 v) is the change in voltage in the capacitor during discharge, and (95%*0.95 v) is the charge on the capacitor before discharge. The net energy discharged in support of maintaining the supply voltage is therefore 7.72 nanojoules. When the single fixed 90 nF capacitor is replaced by a fixed 45 nF capacitor as shown at C3 and a pair of switched voltage stabilizer circuit capacitors C1 and C2 of 22.5 nF each, the energy released under the same conditions as the example of expression [1] is given by expression [2] as follows:

$$2 * 22.5 nF ( 45 \% * 0.95 v ) ( 72.5 * 0.95 v ) + 45 nF ( 10 \% * 0.95 v ) ( 95 \% * 0.95 v ) = 17.1 nJ \qquad [ 2 ]$$

where 2*22.5 nF is the capacitance of the capacitors C1 and C2, (45%*0.95 v) is the change in voltage in each capacitor C1 and C2 during capacitor discharge, and (72.5%*0.95 v) is the charge on the capacitors C1 and C2 before discharge. This amount of energy is added to the fixed capacitor 45 nF times the change in voltage in the capacitor during discharge (10%*0.95 v) and the charge on the capacitor before discharge (95%*0.95 v). The total energy released by this configuration using the same total capacitance of 45 nF of switched capacitors and 45 nF of fixed capacitors is therefore 17.1 nanojoules, or more than double the energy released using a fixed capacitor of 95 nF alone.

This energy stored in capacitors C1 and C2 of the voltage stabilization circuit of FIG. 1 may be released in some examples when the voltage supply V_{CPU} drops below a threshold level, as may be determined by a comparator or other means to switch the state of transistors S1 and S2 and transmission gate S3 from a charging state to a discharging state. In another example, the energy stored in capacitors C1 and C2 may be similarly released based on an observed change in current drawn, by a signal from a processor core 102, or other circuit component indicating an expected change in drawn current such as when a processor turns on or increases its work, or by other such means.

In some embodiments, other circuits on the integrated circuit die represented at 106 may be powered using other circuitry, such as a traditional voltage regulator 108, a traditional bypass capacitor C4, and the like. Such circuits in various examples may include other processor cores (such as efficient processor cores), memory, peripheral circuitry, and the like.

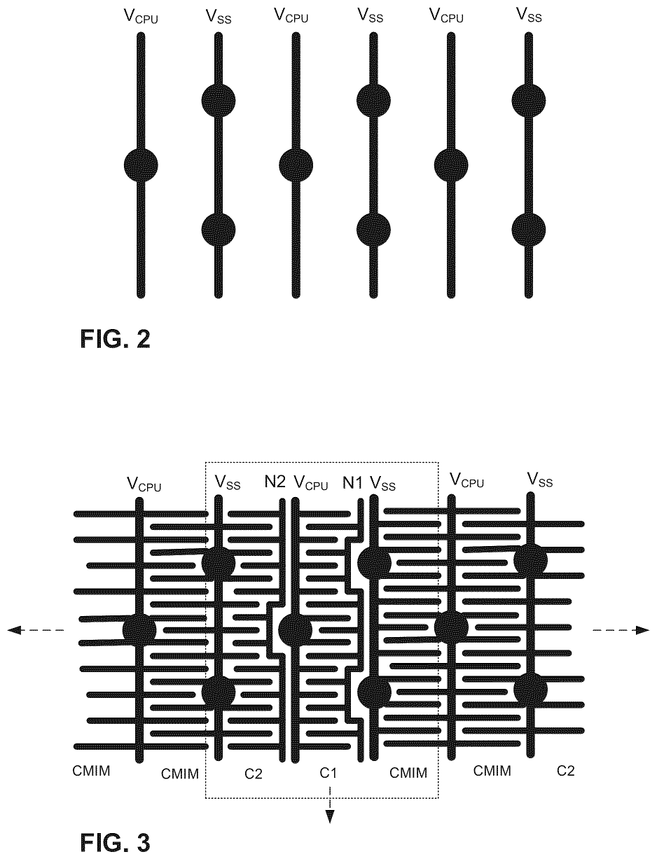

FIG. 2 shows an integrated circuit redistribution layer, as may be used to practice some example embodiments. The simplified redistribution layer shown here comprises an alternating series of power lines, comprising V_{CPU} (or the CPU power supply voltage) and V_{SS} (or ground). The round circles spaced in an offset grid pattern across the power lines are bumps connected to vias that pass the voltage through to other layers in the integrated circuit, providing low impedance power to the integrated circuit layers below.

Because the redistribution layer is not a semiconductor layer, it typically comprises metal traces configured to link external connections such as power and other signals to an attached integrated circuit. The redistribution layer in some examples may expand and redistribute input/output connections for the integrated circuit, such as data bus or control bus lines or other signaling inputs or outputs for the integrated circuit. The redistribution layer may also distribute contact points between the integrated circuit and associated packaging around the integrated circuit area, spreading thermal stress related to mounting across the integrated circuit. The metal elements of the metal-insulator-metal capacitor or capacitors in various examples may include metals such as copper, metal alloys such as copper alloys, doped metal such as copper doped with doping compounds such as to reduce electromigration, or other compounds containing metal or metals.

The first and second capacitors may be charged and discharged using a transmission gate or other suitable switching method. In a further example, the resistance-capacitance (RC) time constant of the discharge circuit is controlled such as through semiconductor process, circuit device configuration or layout, or other such means to provide an RC constant of the first metal-insulator-metal capacitor, the a first metal-insulator-metal capacitor, and the at least one switching circuit of between 0.03 and 0.3 divided by a resonance frequency of a first order voltage droop of the integrated circuit in response to a change in drawn electrical power. In a further example the RC time constant of the first metal-insulator-metal capacitor, the a first metal-insulator-metal capacitor, and the at least one switching circuit of between 0.08 and 0.10 divided by a resonance frequency of a first order voltage droop of the integrated circuit in response to a change in drawn electrical power. Because the desired RC time constant may be somewhat large relative to the typical impedance of a voltage stabilization circuit such as that shown in FIG. 1, the somewhat higher discharge resistance of larger switched capacitors C1 and C2 may have the advantage of reducing the additional resistance needed (such as by modifying the resistance of transmission gate S3) to achieve the desired RC time constant.

FIG. 3 shows a redistribution layer comprising a plurality of switched metal-insulator-metal capacitors that occupy approximately 50% of the overall capacitor area in a redistribution layer, consistent with an example embodiment. Here, the V_{CPU} (or the CPU power supply voltage) and V_{SS} (or ground) redistribution traces are further augmented by capacitor traces N1 and N2 (corresponding to nodes N1 and N2 in FIG. 1), which are coupled externally as voltage stabilization capacitors and are routed on the redistribution layer to have a number of extensions that interleave with extensions from V_{SS} or V_{CPU} to form capacitive structures on the redistribution layer. In this example V_{SS} and V_{CPU} are also coupled to interleaving extensions in some areas of the redistribution layer, such that approximately half the capacitor area comprises a fixed capacitor between V_{SS} and V_{CPU} and half the capacitor area comprises capacitors C1 and C2, where C1 is formed by the interleaving extensions between N1 and V_{CPU} and C2 is formed by the interleaving extensions between N2 and V_{SS}. Capacitors C1 and C2 in this example correspond to the capacitors C1 and C2 of FIG. 1, while the fixed capacitor comprises a capacitor that is not switched by a circuit such as voltage stabilizer circuits 106 and 108 of FIG. 1.

The pattern shown in FIG. 3 in a more detailed example may repeat many times, covering a significant portion of a region of an integrated circuit having a voltage supply stabilized using such capacitor structures, while in further examples the capacitor pattern may repeat to cover all the powered integrated circuit area or may exceed or overhang the integrated circuit area supported by the capacitors and voltage stabilization circuit. The redistribution layer in one such example may be larger than the die coupled to the redistribution layer, and so may provide on-device capacitors larger than would be possible to form on the integrated circuit die itself using other technologies.

In some embodiments, the capacitor structures of FIG. 3 may be coupled to high-speed or high-performance processor cores (and in further examples associated circuitry such as cache memory), which may experience more extreme workload transitions than low-speed or efficient processor cores, and correspondingly higher transitions in drawn current over a short time (di/dt). It may be desirable in such embodiments to couple the capacitor structures shown to high-performance processor cores rather than to efficient processor cores or other circuitry, such that the capacitor structures may overhang the coupled high-performance processor cores or may overlap other circuitry such as efficient processor cores. The dashed lines in FIG. 3 represent a high-performance processor core region of a die, and the capacitor structures overhang the high performance processor core region and overlap other areas of the die having lower demand in experienced current draw change over a short time (di/dt). The capacitor structures of FIG. 3 may therefore be coupled only to those selected portions of a circuit or die that experience the greatest current transients, dedicating a larger capacitance and available stored charge to reducing voltage droop during large or fast current transients.

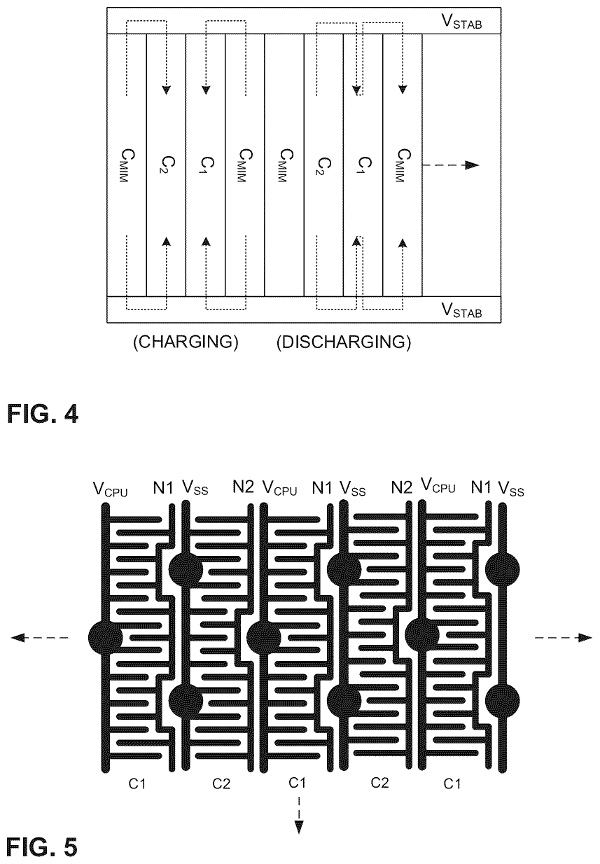

FIG. 4 shows charging and discharging switched capacitors via a voltage stabilization circuit, consistent with an example embodiment. Here, capacitors C1 and C2 correspond to capacitors C1 and C2 of the examples of FIGS. 1 and 3, while the fixed capacitor or capacitors formed by interleaving extensions between V_{SS} and Very are denoted as C_{MIM}. The V_{STAB} areas of FIG. 4 comprise voltage stabilization circuits such as the voltage stabilization circuits of FIG. 1, which in a further example may comprise connections to voltage stabilization circuits formed in other layers such as semiconductor layers of the coupled integrated circuit. The C_{MIM} capacitor area in this example comprises approximately 50% of the physical capacitor area shown, while each of capacitors C1 and C2 comprise approximately 25% of the shown capacitor area. The capacitors C1 and C2 are distributed as shown, so the loop inductance and resistance during charge and discharge are negligible.

The capacitor configuration of FIG. 4 also shows on the left side (the left four capacitors C_{MIM} to C_{MIM}) the flow of current during charging, and on the right side (the right four capacitors C_{MIM} to C_{MIM}) the flow of current during discharging. On the left, the capacitor charging cycle shows how capacitors C1 and C2 are charged from the voltage supply rails (and secondarily from fixed capacitors C_{MIM}) via the voltage stabilizing circuit V_{STAB}, as shown in FIG. 1. When capacitor discharge is triggered, such as via a comparator sensing a drop in supply voltage, a current sensor observing a rapid increase in current drawn, or a signal from a processor or other circuit indicating an anticipated increase in circuit power consumption, the capacitors C2 and C1 discharge through one another in series, again in parallel with or in conjunction with the fixed capacitors C_{MIM}.

More specifically, the fixed capacitors C_{MIM} may in some examples aid in charging the parallel capacitors C1 and C2 during the charging phase, and may temporarily absorb some energy from the capacitors C1 and C2 when in series during the discharging phase. FIG. 5 therefore shows a redistribution layer comprising a plurality of switched metal-insulator-metal capacitors that occupy approximately 50% of the overall capacitor area in a redistribution layer, consistent with an example embodiment. This example does not show a fixed capacitor C_{MIM}, but instead shows that the Vert (or the CPU power supply voltage) and V_{SS} (or ground) redistribution traces are augmented by capacitor traces N1 and N2 to form voltage stabilization capacitors C1 and C2. These capacitor traces N1 and N2 are routed on the redistribution layer to have a number of extensions that interleave with extensions from V_{SS} or V_{CPU} to form capacitive structures C1 and C2, much as in the example of FIG. 3. In a further example, other regions of the redistribution layer may have other capacitors formed thereon, such as capacitors C1 and C2 for other processor cores or other circuits on the integrated circuit die, fixed capacitors C_{MIM}, or other such capacitor structures. As with the example of FIG. 3, the pattern shown here may repeat many times in a further example, covering a significant portion of a region of an integrated circuit having a voltage supply stabilized using such capacitor structures. The capacitor pattern may also repeat to cover all the powered integrated circuit area, or may exceed or overhang the integrated circuit area supported by the capacitors.

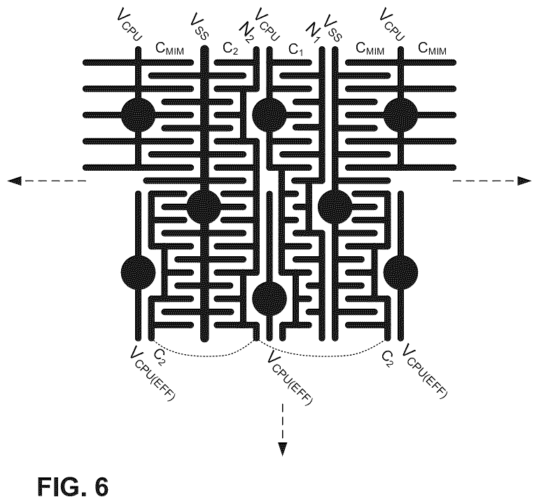

FIG. 6 shows a redistribution layer comprising a plurality of switched metal-insulator-metal capacitors that extend over a die area of processor cores not employing the switched metal-insulator-metal capacitors, consistent with an example embodiment. Here, the redistribution layer includes both V_{CPU} power signals for powering high performance processor cores and V_{CPU(EFF)} power signals for powering high efficiency cores. Because the power signal supplied to the high efficiency cores does not require the same degree of voltage droop support as the power signal supplied to the high performance cores, capacitor structures supporting the power signal supplied to the high performance cores may be designed to extend across the redistribution layer area powering the high efficiency cores.

In the example shown in FIG. 6, V_{CPU} power signals are provided to the high performance processor cores in the top half of the drawing (above the dashed line), while the high efficiency cores in the bottom half of the drawing (below the dashed line) are provided V_{CPU(EFF)} power signals. The Vert power signals in some such examples may be a higher voltage than the V_{CPU(EFF)} power signals, or may be adjusted to a higher voltage level than the voltage of the V_{CPU(EFF)} power signals to support the higher performance cores that have higher voltage and current demands. The capacitors C₂ and C₁ formed in the top half of the drawing extend down through the bottom half of the drawing in this example, and capacitor C₂ is further coupled (as represented by the dotted lines at the bottom of the drawing) to additional capacitor segments that exist only in the bottom half of the drawing where capacitor C_{MIM} is interrupted by a change in supply voltage from V_{CPU} to V_{CPU(EFF)}. These additional capacitor segments and extensions beyond the die area of the high performance cores provide additional capacitance for capacitors C₂ and C₁. This additional capacitance may be used to provide additional current to the high-performance cores powered by the V_{CPU} power signal in the top half of the drawing during periods of power or performance transition, such as from low current demand to high current demand.

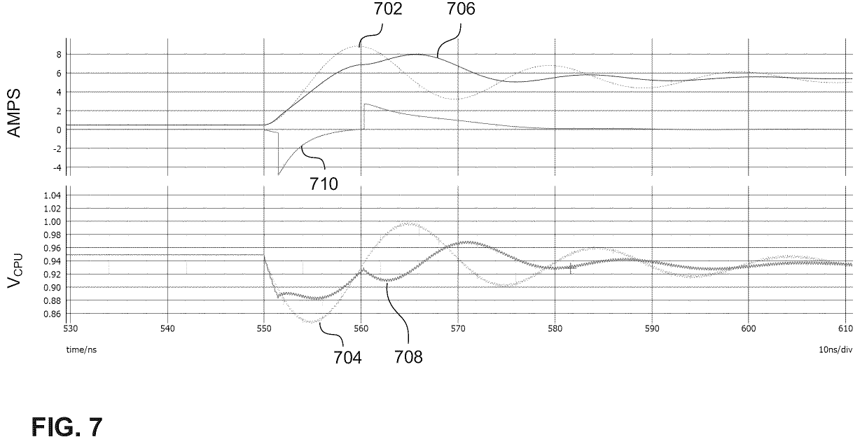

FIG. 7 is a power supply signal timing diagram showing power supply variations with and without a voltage stabilization circuit, consistent with an example embodiment. Here, the voltage V_{CPU} and current in amps are shown vs time in nanoseconds, illustrating how voltage and current may change in response to a change in processor utilization or similar change in state of a coupled integrated circuit. At 550 nanoseconds, an increase in current drawn in an integrated circuit not incorporating a voltage stabilizing circuit is shown at 702. This rapid increase in current drawn results in a corresponding droop in supply voltage as shown at 704, for a voltage drop from 0.95 v to approximately 0.84 v, or a peak drop of 0.11 v.

The same change in current drawn from an attached circuit with a voltage stabilization circuit and switched capacitors such as are shown in the example of FIG. 1 is shown at 706, resulting in a reduced peak current drawn from the power supply and a longer delay from normal current conditions to peak current drawn (from 10 nanoseconds as shown at 702 with no voltage stabilizing circuit to 16 nanoseconds as shown at 706 with a voltage stabilizing circuit). The voltage V_{CPU} supplied to the attached integrated circuit using the voltage stabilization circuit is shown at 708, and reflects a peak voltage droop of about 0.065 v, or slightly over half the voltage droop experience with no voltage stabilizing circuit as shown at 704.

The current released by the voltage stabilization circuit is further shown at 710, reflecting a negative value when the voltage stabilization capacitors are discharging or providing current to stabilize the V_{CPU} voltage, and positive values when the capacitors are recharging to prepare for another voltage stabilization event. The voltage stabilization circuit in this example serves to significantly reduce the amplitude of voltage variations experienced without a voltage stabilization circuit as shown at 704, including both a reduction in peak voltage droop as seen around 550 nanoseconds and a reduction in oscillation as the voltage stabilization circuit changes state and recharges its capacitors starting at around 560 nanoseconds.

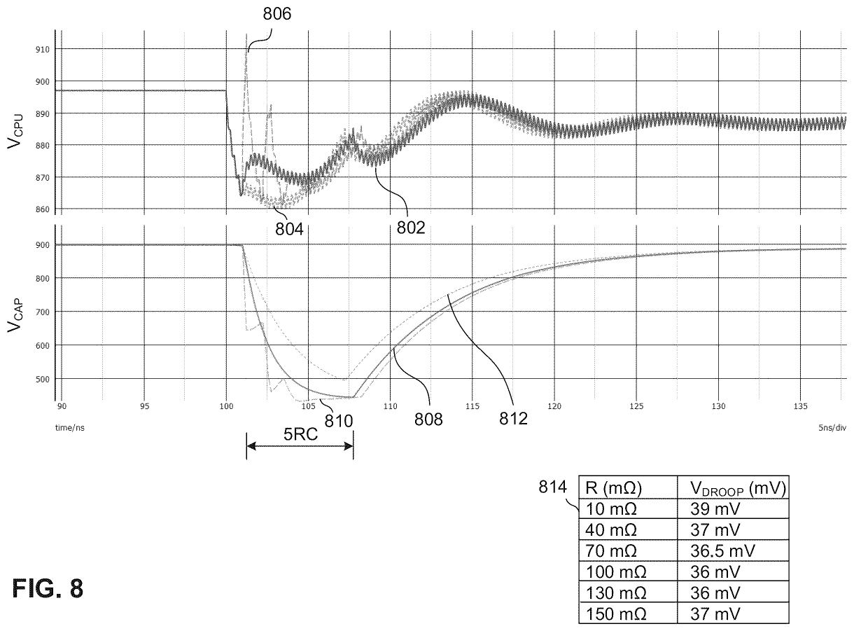

FIG. 8 is a power signal timing diagram showing how selecting a voltage stabilization circuit discharge rate may improve voltage stabilization, consistent with an example embodiment. Here, the voltage curve as observed at the integrated circuit CPU with a voltage stabilization circuit during an increase in drawn current is shown at 804, much like the voltage curve 708 of FIG. 7. The voltage curve 802 represents the voltage observed at the integrated circuit power inputs with a total discharge resistance through capacitors C1 and C2 and the transmission gate S3 of the example circuits of FIG. 8 of approximately 100-130 milliohms, selected such that the RC discharge rate of the voltage stabilizer circuit is approximately 0.09/f₁, where f₁ is the first-order resonant frequency of the voltage droop observed as a result of the change in current. If the resistance is selected to be significantly higher than this, the RC time constant rises and more voltage droop is observed such as in the voltage curve shown at 804. If the resistance is configured to be significantly lower than 100-130 milliohms, additional oscillation in the resulting voltage response may result in undesired voltage peaks as well as voltage droops that may exceed the maximum voltage droop seen in curve 802, as shown at 806.

The voltage curve 808 further illustrates how selecting the discharge resistance R such that RC=0.09/f₁ as measured at the capacitor as shown at 808 results in efficient discharge of the capacitor relative to curve 810 in which the resistance is smaller and more oscillation is observed or curve 812 in which the resistance is higher and the capacitor does not discharge rapidly enough to minimize the voltage droop. A chart of different voltage stabilization circuit resistances and observed resulting voltage droop is further shown at 814, illustrating how voltage droop may be minimized by selecting an appropriate resistance within a limited range of that indicated by the expression RC=0.09/f₁, which may also be expressed as 5RC=0.45/f₁. In further examples, the value of R may be selected to be within a certain range of the value calculated by RC=0.09/f₁, such as RC is between 0.3/f₁ and 0.03/f₁, RC is between 0.06/f₁ and 0.15/f₁, or RC is between 0.08/f₁ and 0.1/f₁. The 5RC=0.45/f₁ expression is further illustrated in FIG. 8 with respect to voltage curve 808 as reflecting that capacitors C1 and C2 of the voltage stabilization circuit are substantially discharged at a time of 5RC, and switch back to a charging mode. This helps damp oscillation of the voltage observed at the integrated circuit or CPU as shown at 802.

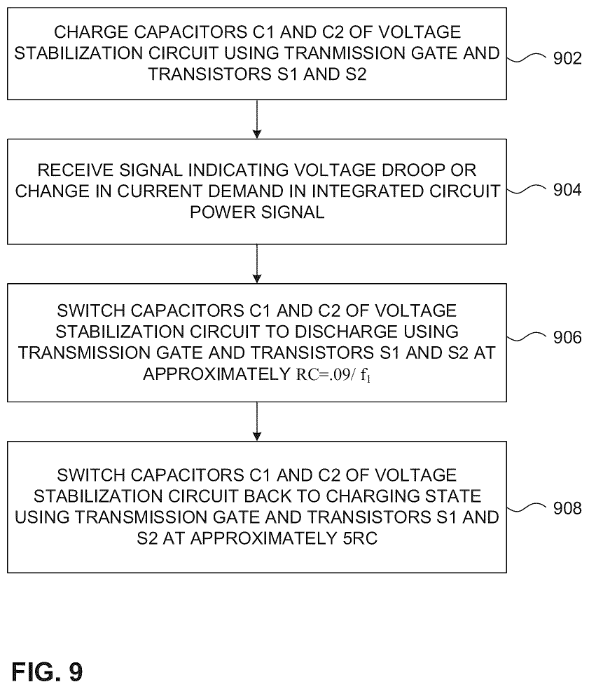

FIG. 9 is a flow diagram of a method of using a voltage stabilization circuit with metal-insulator-metal capacitors to reduce voltage droop in an integrated circuit, consistent with an example embodiment. At 902, a voltage stabilization circuit such as that of FIG. 1 charges its capacitors C1 and C2 such as by coupling them between a power supply line and a ground line by turning on transistors S1 and S2. The transmission gate S3 is turned off and does not conduct. At 904, a signal is received indicating an event such as an increase in current drawn from the integrated circuit, a power signal voltage droop on the integrated circuit, a signal indicating an anticipated increase in integrated circuit current draw such as when a processor core changes power state, or the like. This signal in some examples may be in response to an observed change in condition such as using a comparator to monitor voltage or a current monitoring circuit to detect changes in current flow, and in other examples may be anticipatory or predictive such as a signal changing the power state of a processor core or other circuit.

In response to receiving the signal indicating an increase in power demand, the voltage stabilization circuit changes state at 906. The capacitors C1 and C2 are switched from charging in parallel with one another to discharging in series with one another by turning off transistors S1 and S2 and turning on transmission gate S3. In a more detailed example, the resistance of transmission gate S3 is selected in conjunction with the discharge resistances of capacitors C1 and C2 so that the total resistance and capacitance have a desired RC time constant to minimize voltage droop during a change in power state, such as is shown in the examples of FIGS. 7 and 8. The desired RC time constant in one such example is selected such that RC is approximately equal to 0.09/f₁, where f₁ is the first order resonant frequency of the voltage droop experienced during an increase in power demand from the coupled powered circuit.

After a time of approximately 5RC (as shown and described in greater detail in the example of FIG. 8), the voltage stabilization circuit changes state at 908 from discharging capacitors C1 and C2 in series to charging the capacitors C1 and C2 in parallel by switching off transmission gate S3 and switching on transistors S1 and S2. The voltage stabilization circuit thereby effectively stops providing supplemental power to the coupled circuit and starts recharging the capacitors such as in preparation for another rapid power demand increase.

The examples presented herein demonstrate how use of a voltage stabilization circuit such as that of FIG. 1 can be Employed with Metal-Insulator-Metal Capacitors to Provide significantly improved voltage stabilization to circuits such as processor cores and other integrated circuits. Use of a redistribution layer may enable the capacitors in the voltage stabilization circuit to be relatively large or overhang the powered circuit area in some examples, and be supplemented by a fixed capacitor (such as C_{MIM}) in some examples. Capacitors may be formed on a metal layer such as a redistribution layer of an integrated circuit assembly including capacitors by routing interleaving extensions from one or more power supply conductors and one or more capacitor connections (such as N1 or N2), forming the metal-insulator-metal capacitors of a voltage stabilization circuit. The RC time constant of the voltage stabilization circuit when in discharge mode may further be selected to minimize voltage droop such as by intentionally selecting a desired “on” resistance of a transmission gate such as selecting R such that RC is approximately equal to or within a desired tolerance or range of 0.09/f₁, and/or by changing the discharge state of the voltage stabilization circuit after a period of approximately 5RC.

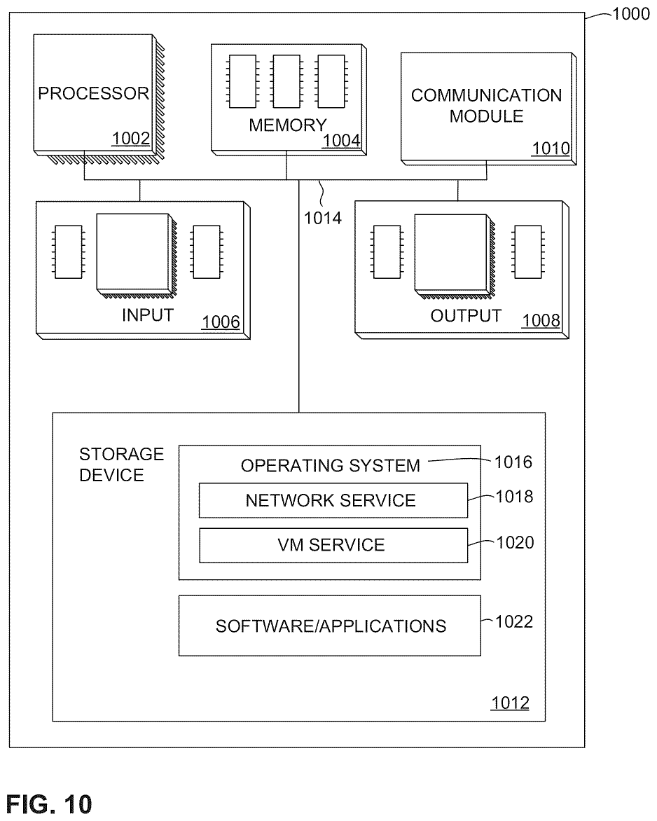

FIG. 10 shows a block diagram of a general-purpose computerized system, consistent with an example embodiment. FIG. 10 illustrates only one particular example of computing device 1000, and other computing devices 1000 may be used in other embodiments. Although computing device 1000 is shown as a standalone computing device, computing device 1000 may be any component or system that includes one or more processors or another suitable computing environment for executing software instructions in other examples, and need not include all of the elements shown here.

As shown in the specific example of FIG. 10, computing device 1000 includes one or more processors 1002, memory 1004, one or more input devices 1006, one or more output devices 1008, one or more communication modules 1010, and one or more storage devices 1012. Computing device 1000, in one example, further includes an operating system 1016 executable by computing device 1000. The operating system includes in various examples services such as a network service 1018 and a virtual machine service 1020 such as a virtual server. One or more applications, such as application 1022 are also stored on storage device 1012, and are executable by computing device 1000.

Each of components 1002, 1004, 1006, 1008, 1010, and 1012 may be interconnected (physically, communicatively, and/or operatively) for inter-component communications, such as via one or more communications channels 1014. In some examples, communication channels 1014 include a system bus, network connection, inter-processor communication network, or any other channel for communicating data. Applications such as software application 1022 and operating system 1016 may also communicate information with one another as well as with other components in computing device 1000.

Processors 1002, in one example, are configured to implement functionality and/or process instructions for execution within computing device 1000. For example, processors 1002 may be capable of processing instructions stored in storage device 1012 or memory 1004. Examples of processors 1002 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 1012 may be configured to store information within computing device 1000 during operation. Storage device 1012, in some examples, is known as a computer-readable storage medium. In some examples, storage device 1012 comprises temporary memory, meaning that a primary purpose of storage device 1012 is not long-term storage. Storage device 1012 in some examples is a volatile memory, meaning that storage device 1012 does not maintain stored contents when computing device 1000 is turned off. In other examples, data is loaded from storage device 1012 into memory 1004 during operation.

Examples of volatile memories include random access memories (RAM), dynamic random access memories (DRAM), static random access memories (SRAM), and other forms of volatile memories known in the art. In some examples, storage device 1012 is used to store program instructions for execution by processors 1002. Storage device 1012 and memory 1004, in various examples, are used by software or applications running on computing device 1000 such as software application 1022 to temporarily store information during program execution.

Storage device 1012, in some examples, includes one or more computer-readable storage media that may be configured to store larger amounts of information than volatile memory. Storage device 1012 may further be configured for long-term storage of information. In some examples, storage devices 1012 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 1000, in some examples, also includes one or more communication modules 1010. Computing device 1000 in one example uses communication module 910 to communicate with external devices via one or more networks, such as one or more wireless networks. Communication module 1010 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 1000 uses communication module 1010 to wirelessly communicate with an external device such as via a public network.

Computing device 1000 also includes in one example one or more input devices 1006. Input device 1006, in some examples, is configured to receive input from a user through tactile, audio, or video input. Examples of input device 1006 include a touchscreen display, a mouse, a keyboard, a voice responsive system, video camera, microphone or any other type of device for detecting input from a user.

One or more output devices 1008 may also be included in computing device 1000. Output device 1008, in some examples, is configured to provide output to a user using tactile, audio, or video stimuli. Output device 1008, in one example, includes a display, a sound card, a video graphics adapter card, or any other type of device for converting a signal into an appropriate form understandable to humans or machines. Additional examples of output device 1008 include a speaker, a light-emitting diode (LED) display, a liquid crystal display (LCD or OLED), or any other type of device that can generate output to a user.

Computing device 1000 may include operating system 1016. Operating system 1016, in some examples, controls the operation of components of computing device 1000, and provides an interface from various applications such as software application 1022 to components of computing device 1000. For example, operating system 1016, in one example, facilitates the communication of various applications such as software application 1022 with processors 1002, communication unit 1010, storage device 1012, input device 1006, and output device 1008. Applications such as application 1022 may include program instructions and/or data that are executable by computing device 1000. These and other program instructions or modules may include instructions that cause computing device 1000 to perform one or more of the other operations and actions described in the examples presented herein.

Process cores, bitcell arrays, memory structures, peripheral circuitry, and other circuits as described herein in particular examples may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Features of example computing devices employed in example embodiments may comprise features, for example, of a client computing device and/or a server computing device. The term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1 and in the text associated with the foregoing figure(s) of the present patent application.

Some embodiments may be described, at least in part, by the following numbered clauses or by any combination thereof:

Clause 1: An integrated circuit assembly, comprising: a plurality of die connection points configured to couple to an integrated circuit die; a plurality of external connection points configured to couple to external circuitry; a metal power signal trace and a metal ground signal trace, the metal power signal trace and metal ground signal trace each coupled to at least a respective one of the plurality of die connection points to provide electrical power to the integrated circuit; a first metal-insulator-metal capacitor comprising a plurality of first extensions interleaved with a plurality of extensions of the metal power signal trace and separated from the plurality of extensions of the metal power signal trace by an insulator; and a second metal-insulator-metal capacitor comprising a plurality of second extensions interleaved with a plurality of extensions of the metal ground signal trace and separated from the plurality of extensions of the metal ground signal trace by an insulator.

Clause 2: The integrated circuit assembly of clause 1, further comprising at least one switching circuit selectively coupling the first metal-insulator-metal capacitor and the second metal-insulator-metal capacitor to charge when in a first state and coupling the first metal-insulator-metal capacitor and second metal-insulator-metal capacitor to provide electrical power to the integrated circuit when in a second state.

Clause 3: The integrated circuit assembly of any of the aforementioned clauses, wherein the at least one switching circuit comprises a transmission gate.

Clause 4: The integrated circuit assembly of any of the aforementioned clauses, wherein the at least one switching circuit is selectively switched in response to at least one of an electrical power current change, an electrical power voltage change, or a signal from the integrated circuit indicating an anticipated change in drawn electrical power.

Clause 5: The integrated circuit assembly of any of the aforementioned clauses, wherein an R-C constant of the a first metal-insulator-metal capacitor, the a first metal-insulator-metal capacitor, and the at least one switching circuit is between 0.03 and 0.3 divided by a resonance frequency of a voltage droop of the integrated circuit in response to a change in drawn electrical power.

Clause 6: The integrated circuit assembly of clause 5 or any of the aforementioned clauses, wherein the R-C constant of the a first metal-insulator-metal capacitor, the a first metal-insulator-metal capacitor, and the at least one switching circuit is between 0.08 and 0.10 divided by a first order resonance frequency of the voltage droop of the integrated circuit in response to a change in drawn electrical power.

Clause 7: The integrated circuit assembly of any of the aforementioned clauses, wherein the first metal-insulator-metal capacitor and second metal-insulator-metal have approximately a same capacitance.

Clause 8: The integrated circuit assembly of any of the aforementioned clauses, wherein at least one of the first and second metal-insulator-metal capacitors extends outside an area of circuitry powered by the metal power signal trace.

Clause 9: The integrated circuit assembly of any of the aforementioned clauses, wherein the metal power signal trace, the first metal-insulator-metal capacitor, and the second metal-insulator-metal capacitor comprise part of a redistribution layer.

Clause 10: The integrated circuit assembly of any of the aforementioned clauses, wherein at least one of the first metal-insulator-metal capacitor and second metal-insulator-metal capacitors comprises a plurality of parallel capacitors.

Clause 11: An article comprising a non-transitory computer-readable medium to store computer-readable hardware description language code for fabrication of a device, the device comprising: a plurality of die connection points configured to couple to an integrated circuit die; a plurality of external connection points configured to couple to external circuitry; a metal power signal trace and a metal ground signal trace, the metal power signal trace and metal ground signal trace each coupled to at least a respective one of the plurality of die connection points to provide electrical power to the integrated circuit; a first metal-insulator-metal capacitor comprising a plurality of extensions interleaved with a plurality of extensions of the metal power signal trace and separated from the plurality of extensions of the metal power signal trace by an insulator; and a second metal-insulator-metal capacitor comprising a plurality of second extensions interleaved with a plurality of extensions of the metal ground signal trace and separated from the plurality of extensions of the metal ground signal trace by an insulator.

Clause 12: The article of clause 11, the device further comprising at least one switching circuit selectively coupling the first metal-insulator-metal capacitor and the second metal-insulator-metal capacitor to charge when in a first state and coupling the first metal-insulator-metal capacitor and second metal-insulator-metal capacitor to provide electrical power to the integrated circuit when in a second state.

Clause 13: The article of any of clauses 11-12, wherein the at least one switching circuit comprises a transmission gate.

Clause 14: The article of any of clauses 11-13, wherein the at least one switching circuit is selectively switched in response to at least one of an electrical power current change, an electrical power voltage change, or a signal from the integrated circuit indicating an anticipated change in drawn electrical power.

Clause 15: The article of any of clauses 11-14, wherein an R-C constant of the a first metal-insulator-metal capacitor, the a first metal-insulator-metal capacitor, and the at least one switching circuit is between 0.03 and 0.3 divided by a resonance frequency of a voltage droop of the integrated circuit in response to a change in drawn electrical power.

Clause 16: The article of any of clauses 11-15, wherein the R-C constant of the a first metal-insulator-metal capacitor, the a first metal-insulator-metal capacitor, and the at least one switching circuit is between 0.08 and 0.10 divided by a first order resonance frequency of the voltage droop of the integrated circuit in response to a change in drawn electrical power.

Clause 17: The article of any of clauses 11-16, wherein at least one of the first and second metal-insulator-metal capacitors extends outside an area of circuitry powered by the metal power signal trace.

Clause 18: An on-device capacitor structure, comprising: an integrated circuit contained within a package; at least one capacitor further contained within the package; and a switching circuit operable to selectively couple the at least one capacitor to charge when in a first state and couple the at least one capacitor to provide electrical power to the integrated circuit when in a second state, the at least one capacitor and switching circuit having an R-C constant selected, at least in part, based on a resonance frequency of a first order voltage droop of the integrated circuit in response to a change in drawn electrical power.

Clause 19: The on-device capacitor structure of clause 18, wherein the R-C constant of the at least one capacitor and the switching circuit is between 0.05 and 0.15 divided by the resonance frequency of the first order voltage droop of the integrated circuit in response to a change in drawn electrical power.

Clause 20: The on-device capacitor structure of any of clauses 18-19, wherein the at least one switching circuit comprises a transmission gate.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. An integrated circuit assembly, comprising:
a plurality of die connection points configured to couple to an integrated circuit die;
a plurality of external connection points configured to couple to external circuitry;
a metal power signal trace and a metal ground signal trace, the metal power signal trace and metal ground signal trace each coupled to at least a respective one of the plurality of die connection points to provide electrical power to the integrated circuit;
a first metal-insulator-metal capacitor comprising a plurality of first extensions interleaved with a plurality of extensions of the metal power signal trace and separated from the plurality of extensions of the metal power signal trace by a first insulator; and
a second metal-insulator-metal capacitor comprising a plurality of second extensions interleaved with a plurality of extensions of the metal ground signal trace and separated from the plurality of extensions of the metal ground signal trace by a second insulator.

2. The integrated circuit assembly of claim 1, further comprising at least one switching circuit selectively coupling the first metal-insulator-metal capacitor and the second metal-insulator-metal capacitor to charge when in a first state and coupling the first metal-insulator-metal capacitor and second metal-insulator-metal capacitor to provide electrical power to the integrated circuit when in a second state.

3. The integrated circuit assembly of claim 2, wherein the at least one switching circuit comprises a transmission gate.

4. The integrated circuit assembly of claim 2, wherein the at least one switching circuit is selectively switched in response to at least one of an electrical power current change, an electrical power voltage change, or a signal from the integrated circuit indicating an anticipated change in drawn electrical power.

5. The integrated circuit assembly of claim 2, wherein an R-C constant of the a first metal-insulator-metal capacitor, the a first metal-insulator-metal capacitor, and the at least one switching circuit is between 0.03 and 0.3 divided by a resonance frequency of a voltage droop of the integrated circuit in response to a change in drawn electrical power.

6. The integrated circuit assembly of claim 5, wherein the R-C constant of the a first metal-insulator-metal capacitor, the a first metal-insulator-metal capacitor, and the at least one switching circuit is between 0.08 and 0.10 divided by a first order resonance frequency of the voltage droop of the integrated circuit in response to a change in drawn electrical power.

7. The integrated circuit assembly of claim 1, wherein the first metal-insulator-metal capacitor and second metal-insulator-metal have approximately a same capacitance.

8. The integrated circuit assembly of claim 1, wherein at least one of the first and second metal-insulator-metal capacitors extends outside an area of circuitry powered by the metal power signal trace.

9. The integrated circuit assembly of claim 1, wherein the metal power signal trace, the first metal-insulator-metal capacitor, and the second metal-insulator-metal capacitor comprise part of a redistribution layer.

10. The integrated circuit assembly of claim 1, wherein at least one of the first metal-insulator-metal capacitor and second metal-insulator-metal capacitors comprises a plurality of parallel capacitors.

11. An article comprising a non-transitory computer-readable medium to store computer-readable hardware description language code for fabrication of a device, the device comprising:
a plurality of die connection points configured to couple to an integrated circuit die;
a plurality of external connection points configured to couple to external circuitry;
a metal power signal trace and a metal ground signal trace, the metal power signal trace and metal ground signal trace each coupled to at least a respective one of the plurality of die connection points to provide electrical power to the integrated circuit;
a first metal-insulator-metal capacitor comprising a plurality of extensions interleaved with a plurality of extensions of the metal power signal trace and separated from the plurality of extensions of the metal power signal trace by a first insulator; and
a second metal-insulator-metal capacitor comprising a plurality of second extensions interleaved with a plurality of extensions of the metal ground signal trace and separated from the plurality of extensions of the metal ground signal trace by a second insulator.

12. The article of claim 11, the device further comprising at least one switching circuit selectively coupling the first metal-insulator-metal capacitor and the second metal-insulator-metal capacitor to charge when in a first state and coupling the first metal-insulator-metal capacitor and second metal-insulator-metal capacitor to provide electrical power to the integrated circuit when in a second state.

13. The article of claim 12, wherein the at least one switching circuit comprises a transmission gate.

14. The article of claim 12, wherein the at least one switching circuit is selectively switched in response to at least one of an electrical power current change, an electrical power voltage change, or a signal from the integrated circuit indicating an anticipated change in drawn electrical power.

15. The article of claim 12, wherein an R-C constant of the a first metal-insulator-metal capacitor, the a first metal-insulator-metal capacitor, and the at least one switching circuit is between 0.03 and 0.3 divided by a resonance frequency of a voltage droop of the integrated circuit in response to a change in drawn electrical power.

16. The article of claim 15, wherein the R-C constant of the a first metal-insulator-metal capacitor, the a first metal-insulator-metal capacitor, and the at least one switching circuit is between 0.08 and 0.10 divided by a first order resonance frequency of the voltage droop of the integrated circuit in response to a change in drawn electrical power.

17. The article of claim 11, wherein at least one of the first and second metal-insulator-metal capacitors extends outside an area of circuitry powered by the metal power signal trace.

18. An on-device capacitor structure, comprising:
an integrated circuit contained within a package;
at least one capacitor further contained within the package; and
a switching circuit operable to selectively couple the at least one capacitor to charge when in a first state and couple the at least one capacitor to provide electrical power to the integrated circuit when in a second state, the at least one capacitor and switching circuit having an R-C constant selected, at least in part, based on a resonance frequency of a first order voltage droop of the integrated circuit in response to a change in drawn electrical power.

19. The on-device capacitor structure of claim 18, wherein the R-C constant of the at least one capacitor and the switching circuit is between 0.05 and 0.15 divided by the resonance frequency of the first order voltage droop of the integrated circuit in response to a change in drawn electrical power.

20. The on-device capacitor structure of claim 18, wherein the at least one switching circuit comprises a transmission gate.
